(19) United States
(12) Patent Application Publication
(10) Pub. No.: US 2010/0194920 A1
(43) Pub. Date: Aug. 5, 2010

(54) BEHAVIORALLY-BASED SOFTWARE ACCELERATION FOR DIGITAL CAMERA OPERATIONS

(76) Inventors: Bowei Gai, Flushing, NY (US); Osei Poku, Pittsburgh, PA (US); Henry Teng, Cupertino, CA (US)

Correspondence Address: Bowei Gai, 884 San Simeon Dr., Mountain View, CA, 94043, US

(21) Appl. No.: 12/469,703

(22) Filed: May 21, 2009

Related U.S. Application Data
(60) Provisional application No. 61/149,351, filed on Feb. 3, 2009.

(51) Int. Cl. H04N 5/76; H04N 5/228

(52) U.S. Cl. 348/231.2; 348/222.1; 348/E05.031

(57) ABSTRACT

The perceived speed of a digital camera is greatly depended on the actual speed of the processor as well as the size of the captured image. Behaviorally-based software techniques can improve the speed of the image captures and post-capture actions perceived by the end user without the need for any hardware changes. This is made possible by prioritizing the processing queue to deliver the most important user feedback first, then processing the less time-critical information at a later time. Overall this technique delivers better performance with minimal added processing, and no need of additional hardware.

### CROSS-REFERENCE TO RELATED APPLICATIONS

This application claims priority under 35 U.S.C. 119(e) to U.S. Provisional Patent Application No. 61/149,351 filed Feb. 3, 2009, of Gai, et. al, for BEHAVIORALLY-BASED SOFTWARE ACCELERATION FOR DIGITAL CAMERA OPERATION, which U.S. Provisional Patent Application is hereby fully incorporated herein by reference.

### FIELD OF THE INVENTION

The invention generally relates to the field of digital photography, particularly the methods of accelerating image captures and post-capture actions on the digital camera device based on user behaviors.

### BACKGROUND INFORMATION

User behavior for image captures on a digital camera is typically irregular and sporadic. Common behavioral patterns indicate that most camera users spent significant time to frame shots and to review the captured images in a typical image capturing session. Due to this user behavior, the load of the device's processors is unbalanced and varies drastically. The processor is under very light load between shots and during shot preparation. In contrast, the processor is under extremely heavy load during image processing, which often leads to lagging and perceived long delay between image operations.

The proposed method accelerates the process by intelligently rearranging and prioritizing tasks in the camera operation sequence.

To understand this, consider a typical image capture sequence in a digital camera session breaks down as three major procedures: ‘capture’, ‘tweak’, and ‘record’. Each of these procedures breaks down into smaller discrete tasks. During a series of image captures, a number of these tasks must be completed for each capture prior to other captures. Tasks, such as ‘initialize sensor’ and ‘readout sensor values’, must be completed immediately, while other tasks, such as ‘image manipulation’ and ‘image conversion’, can be postponed. Since the camera processor is only under heavy usage a fraction of the time, the proposed method amortizes the process load in a way to accelerate the user's image capturing and viewing experience.

Aside from intelligently queuing tasks, camera viewfinder's small resolution also contributes to the accelerate feedback in this method. Camera viewfinder resolution ranges generally ranges from one-tenth to one-hundredth of the actual image resolution. Manipulation of the image on the viewfinder for immediate feedback does not require processing of the full resolution image, hence the processing requirements for the on-screen actions are minimal in comparison to that of full size images. This resolution independent method greatly helps to reduce image processing time without any changes to the device hardware.

The method is particularly useful to alleviate the underpowered mobile processors like ones commonly found on camera-embedded phones.

### SUMMARY OF THE INVENTION

This invention addresses the few key issues mentioned above. It utilizes behaviorally-based software methods to minimize the perceived long delay in digital cameras. The invention is a combination of two complimentary set of procedures, ‘process’ and ‘feedback’.

The first half of the method is the ‘process’ step. In this step, the list of tasks is divided based on whether or not the particular task must be completed prior to other captures. The list of tasks is further arranged in the order of a preset capture sequence and assigns a priority to each item.

In an accelerated software ‘capture’ sequence, the must-complete tasks executes first in the correct order. Once this completes, the method provides immediate ready signal feedback to the user to acknowledge that the camera is ready for other actions. If there are no further actions from the user, the method continues to process remaining tasks in the preset capture sequence.

In the case that there is a feedback from the user to initiate another capture, the method immediately puts remaining tasks on hold in memory and processes the must-complete tasks from the second capture. Once all must-complete tasks are completed, the method provides ready signal feedback to the user and resumes the previous work on remaining tasks.

Minimizing time between image capture and ready feedback greatly improves the capture delays between images, typically achieving a minimum of 2-3× improvement for the end user depending on the device configuration. However, the method is imperfect. Because the method relies on storing information in memory for fast access, it is limited by the memory size, which could be relatively low in mobile devices. This limitation will be less of an issue as the mobile device memory inevitably increases in the future.

Complimentary to the ‘process’ step in the invention is the ‘feedback’ step. In this step, the method acknowledges that the image has been taken and is ready for the user to either take post-capture actions on the images or capture more images. There are many post-capture actions available. Most of these actions can be categories into three main objectives detailed below.

One objective of the post-capture action is to visualize the captured images. This can be achieved in a non-intrusive way by showing a thumbnail of the latest capture. Furthermore, it would be possible to expand the thumbnail visualizations to encompass the capture history and the entire camera album. This enables the possibility to visualize all of the images in an album right on the camera viewfinder without the need to exit the camera's capture mode.

Another objective of the post-capture action is to have the ability to manipulate and enhance the captured images. This includes but is not limited to enlarging the picture for inspection, deleting/moving the picture location, and enhancing the image with simple filters such as grayscale. This enables the possibility to manipulate and enhance images right on the camera viewfinder without the need to exit the camera's capture mode.

Another objective of the post-capture action is the share captured images. This includes but is not limited to emailing, posting to forums, uploading to various services, and collaborating with others. This enables the possibility to share images right on the camera viewfinder without the need to exit the camera's capture mode.

All of the post-capture actions are available on the viewfinder inside of the camera application. This further accelerates the camera operations to the end user by providing immediate access and feedback.

A further aspect of the invention focuses on improving the method by dynamically updating the task priority by continuously tracking usage behavior. As an example, if the user's behavior is inclined to inspect each image taken, the method increases the priority on the tasks to create the fastest feedback. Alternatively, if the user's behavior takes as many images as possible without inspection, the method would decrease the feedback priority and increase priority on the capture speed. This aspect of the invention further accelerates the camera operations by customizing the processing order to the habits of the particular camera user.

### BRIEF DESCRIPTION OF THE DRAWINGS

The invention is further illustrated by the following drawings in which:

FIG. 1 shows a generalized block diagram for standard operations flow on a digital camera.

FIG. 2 shows a corresponding block diagram for the propose operations flow on a digital camera.

FIG. 3 compares the difference in perceived processing time between the general method and the proposed method.

FIG. 4 compares the memory map utilization between the standard and the proposed camera operation method.

FIG. 5 shows a sample behavioral analysis using the proposed method.

FIG. 6 illustrates the uses of behavioral data to dynamically prioritize the task queue in the proposed method.

FIG. 7 illustrates the proposed software acceleration from the camera user's perspective.

FIG. 8 illustrates the preview aspects of the interactive on-screen feedback.

FIG. 9 illustrates additional preview features of the interactive on-screen feedback.

FIG. 10 illustrates the image management aspects of the interactive on-screen feedback.

FIG. 11 illustrates the extensibility of the interactive on-viewfinder menu.

FIG. 12 illustrates the ability to execute other applications on the interactive screen.

FIG. 13 illustrates the capability to provide additional non-image information to the end user through the interactive interface.

FIG. 14 illustrates the capability for the user to receive live update through the interactive interface.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The present invention comprises a method and system for accelerating operations on a camera device by obfuscating the long processing time of camera operations with immediate and comprehensive user feedback.

In one aspect of the invention, the system provides a comprehensive, bidirectional, interactive on-screen feedback to the user such that the actual progress of a camera operation is irrelevant to the user. The user can view, manipulate, and perform actions to the captured image on viewfinder so the user is neither aware nor is impacted by the actual progress of the camera operation quietly processing in the background.

In another aspect of the invention, upon any camera operation request from the user, the system completes only the minimal tasks prior to immediately providing proposed feedback to the user. The remaining tasks are intelligently queued and processed at a later time when the processor becomes available.

The combination of these two aspects of the invention creates a greatly accelerated digital camera user experience. The present invention can be implemented purely using camera software, without the need to incur any additional hardware cost.

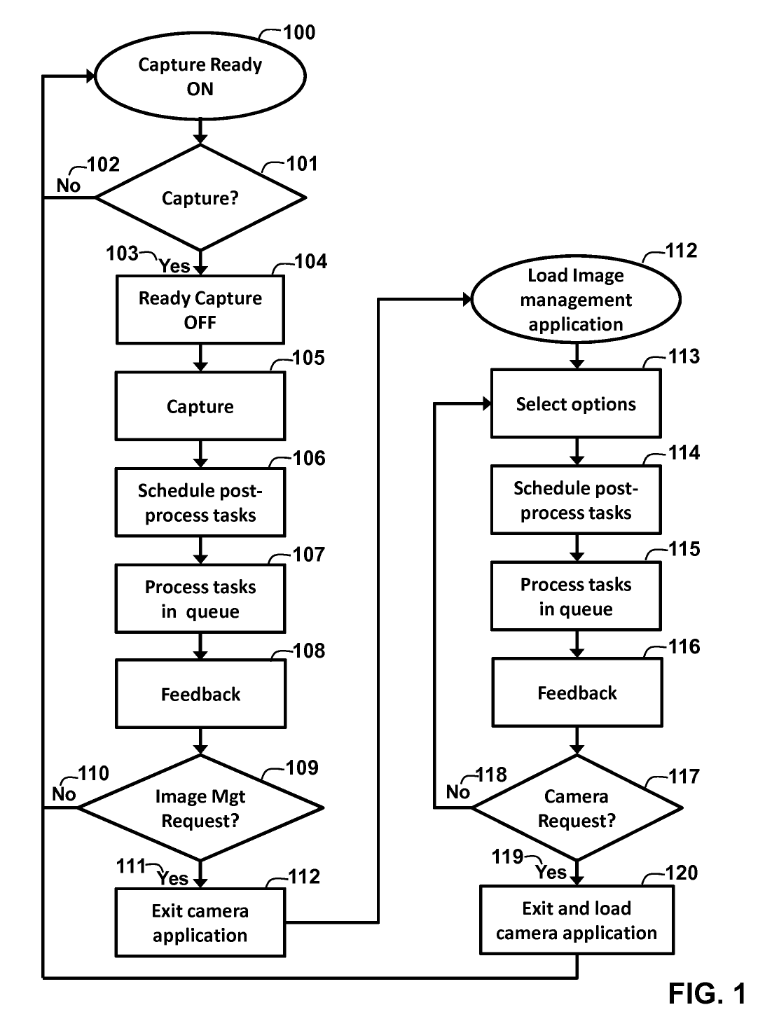

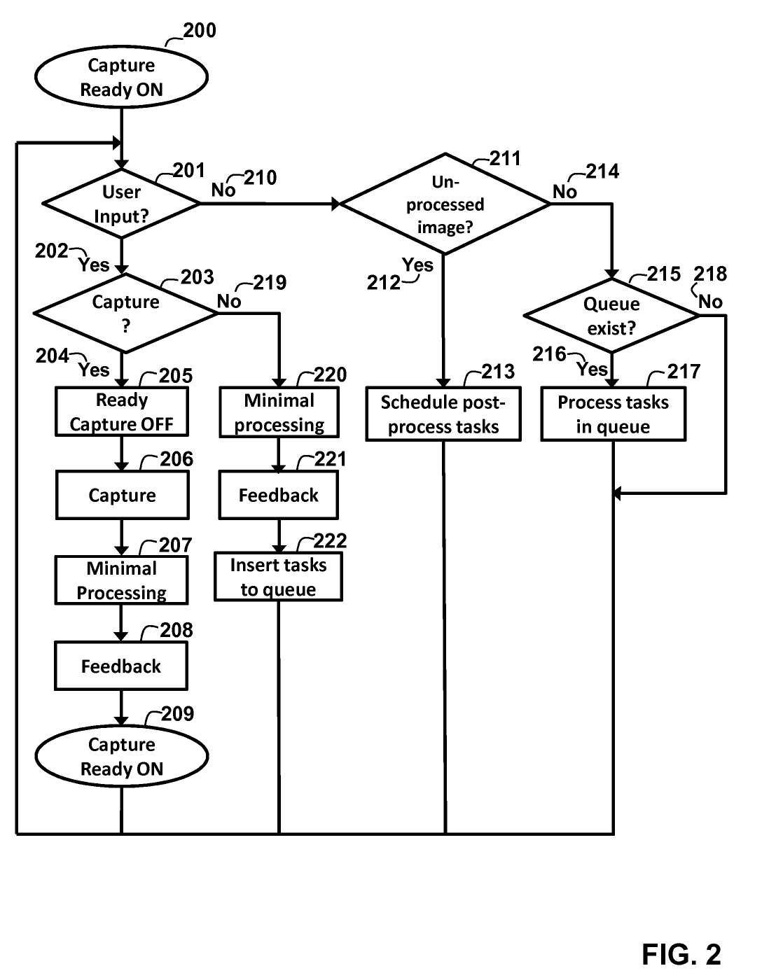

Referring now to FIG. 1, a generalized block diagram for standard operations flow on a digital camera. The standard operations flow is shown in comparison to the corresponding flow of the proposed method in FIG. 2.

As assumptions, the digital camera device in the descriptions utilizes a digital sensor to capture images. It is also assumed that the digital camera utilizes a digital screen to frame, view, or manipulate digital images. The camera application refers to the underlying device software that controls the camera hardware and interacts with the camera user. Additionally, all descriptions apply to both standalone digital cameras as well as embedded digital camera in multimedia devices.

The flow starts when the camera capture application initializes and enters shooting mode. Once the initialization completes and the camera application is ready for captures, the application signals Capture Ready On 100 and indicates to user its readiness. Camera application remains in this state awaits for the capture request 101, and capture Ready 100 remains on when there is no capture request 102. Upon detecting a capture request 103, the application turns off its Ready Capture 104 signals and initiates the image capture step 105.

The image capture step 105 exposes of the on-board digital camera sensors to external light for a brief moment and records illumination data in its sensors. These raw sensor values then runs through a series of image post-process steps before the application produces the final image. These post-process steps include but are not limited to various filters, data transfers, file conversions and pixel manipulations. The application schedules these tasks in a task queue 106 and processes these tasks accordingly 107. Due to computationally-intensive nature of these computations, these post-process steps usually result in a noticeable delay in cameras.

Once the application completes tasks in the task queue, the camera application provides a feedback 108 to acknowledge to the user that the camera is ready for image management request 109. If there is no pending image management request 110, the application loops back to Capture Ready ON 100 state in preparation for more image capture request 101. If there is an image management request 111, the camera capture application exits 112 and initiates the image management application 113.

The image management application allows the user to perform a variety of image operations. These include but are not limited to manipulating the image using different filters such as “black and white” or “red-eye reduction”, sharing the image using email or online services, deleting/renaming/moving images and other operations. The user selects any of the available options 113, and the application schedules 114 and processes 115 the tasks in the task queue. Depending on the operation, this might also result in noticeable delays to the end user. Once all tasks complete, the application provides feedback 116 to acknowledge the completion of these tasks. Simultaneously, it provides options for the user to either return to the camera capture mode 117 or initiate another image management request.

If the user chooses to return to the camera capture mode 117, the image management application exits image management application and loads camera capture application 120. If the user chooses not to return to camera capture mode 118, the application returns to image management application main menu to allow the user to select other image management options 113.

Digital cameras operations vary in minor detail, but it can be generalized by the diagram in FIG. 1. However, in all digital cameras the processing steps in capture 107 and post-capture 115 operations are computational-intensive, which often leads to noticeable delays to the end user.

Referring now to FIG. 2, a corresponding block diagram for the propose operations flow on a digital camera. This is shown in comparison to the standard camera operation flow shown in FIG. 1.

The present invention addresses the issue of significant processing delay that exhibits on most digital cameras, which results in poor responsiveness to the end user. The present invention propose a method to intelligently allocate computing cycles to produce the fastest user feedback possible, and postponing the time-uncritical tasks for processor low-duty times. While the total processing time for the camera operation does not improve, the delay between user action and camera feedback is significantly reduced. By further analyzing the user's behavior, the proposed method can provide near instantaneous feedback to the user. Since camera feedback is the only way a user can judge camera's readiness and responsiveness, it is thus possible to accelerate camera operations utilizing only software methods as proposed.

The proposed method assumes that typical camera processor utilization is much than 100% during its ON state. Standard camera usage flow typically consists of image framing, capturing, reviewing, and modifying steps. In most steps, the device's processor is at virtually 0% utilization. When the device processor is under heavy utilization, it typically becomes a bottleneck in the processor which results in long delays. The proposed method reliefs the utilization bottleneck and amortize the device's processor utilization over a wider period, under which the processor is fully utilized.

The flow starts at when the camera capture application initializes and enters shooting mode. Once the initialization completes and the camera application is ready for captures, the application signals Capture Ready On 200 and indicates to the user its readiness. The application proceeds to detect any user input request 201. Upon detecting a user input 202, the application verifies if the input is an image capture request 203. When the application confirms an image capture request 204, it turns off the Ready Capture 205 signal and proceeds to capture 206 an image. The application processes only the minimal time-critical tasks 207 to capture an image 206, and immediately provides a feedback 208 to acknowledge to the user that the camera is ready for another quick image capture 209. This image remains in an unprocessed state until the application processes this image. By avoiding the time-consuming processing, the proposed method significantly reduces the long delay between camera's image captures.

Once Capture Ready ON 209 is set, the application detects for additional user inputs 201. If no user inputs are detected 210, the application then proceeds to detect any unprocessed images 211 in task queue. If unprocessed image exists 212, the application schedules the necessary post-process tasks 213 to the task queue.

If there is neither a user input 210 nor any unprocessed image waiting 214, the application then checks if any tasks exist in the task queue 215. If yes 216, the application process a task 217 and proceeds to check for new user input 201. If not 218, the application returns to check for new inputs 201.

If the user input is non-capture image request, the proposed method also utilizes the same framework to provide expedited feedback and postpone the time-uncritical tasks. The application receives a user input 201 and determines that it is not 219 a capture request 203. The application completes the minimal processing 220 and provides immediate feedback to the user 221. The application then adds the time-uncritical tasks the task queue 222 similar to that of camera capture request procedure. These non-capture image requests can be any camera software operation, such as email, upload, image manipulation and image management.

The most significant difference between the proposed method and the existing standard method is this concept of minimal processing 207 prior to providing feedback 208. Instead of completing the post-capture processing tasks in the existing methods, the proposed method processes only the mandatory time-critical tasks and postpones the time-uncritical tasks for later. Depending on the user's requests, the proposed method intelligently finds the best time to complete the remaining tasks. An example of time-critical tasks is reading of the image sensor value, which must be done as soon as possible. An example such time-uncritical tasks is compressing the raw image values into a smaller file, which can be done at anytime as long as the raw image values are available.

From the end-user perspective, camera operations under the proposed method are considerably faster. To perform same operations, the proposed method typically cutting the feedback delay time from one-half to one-fifth depending on the operation. Since the user cannot be aware that the bulk of the processing is done when the user is not actively using the camera (e.g. framing a shot), the end result is acceleration for camera operations purely done in software without any hardware assistance.

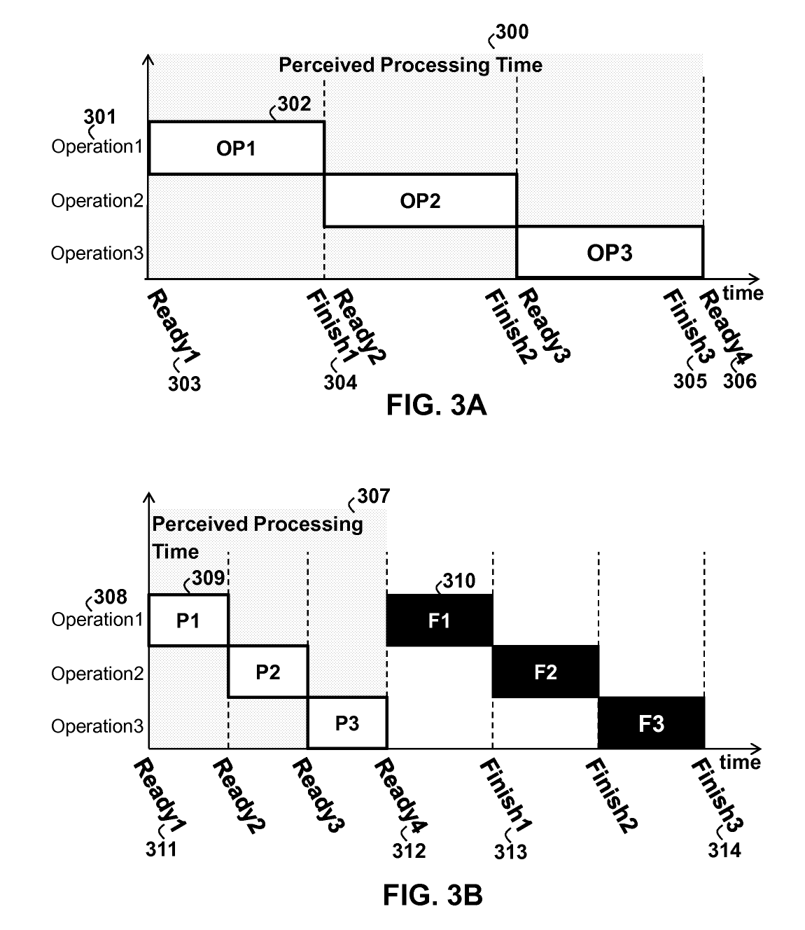

FIGS. 3A and 3B compare the difference in perceived processing time between the general method and the proposed method. In both figures, the camera receives three back-to-back camera operation requests.

Referring now to FIG. 3A, a chart of the Perceived Processing Time for the general camera operation method 300. The perceived time is shown in gray and it spans from Ready2 303 to Finish3 306. The three back-to-back camera operations are denoted Operation1 301, Operation2 and Operation3. The corresponding processing time for these operations are OP1 302, OP2 and OP3 respectively. The time between Ready1 303 and Finish1 304 is the time it takes to process camera operation #1 in a typical camera. Conversely, a camera is only ready for another operation when the prior camera operation is complete. Since the method processes the photos serially, the Perceived Processing Time 300 is the sum of the individual operational time at Finish3 305 or Ready4 306.

Continuing now with the FIG. 3B, a chart of the Perceived Processing Time for the proposed camera operation method 307. The application also completes Operation1 308, Operation2, and Operation3 back-to-back as a comparison. Instead of one complete set of processes similar to OP1 302, the proposed method breaks down the processing into two halves, P1 309 and F1 310. The former is the time-critical minimal tasks in order to display a preview on the viewfinder, which is processed immediately upon a request. The latter is rest of the time-uncritical tasks in the requested camera operation, which is processed later when the device processor is not under heavy load. The first camera operation completes at time Finish1 313 and all three camera operations completes at time Finish3 314.

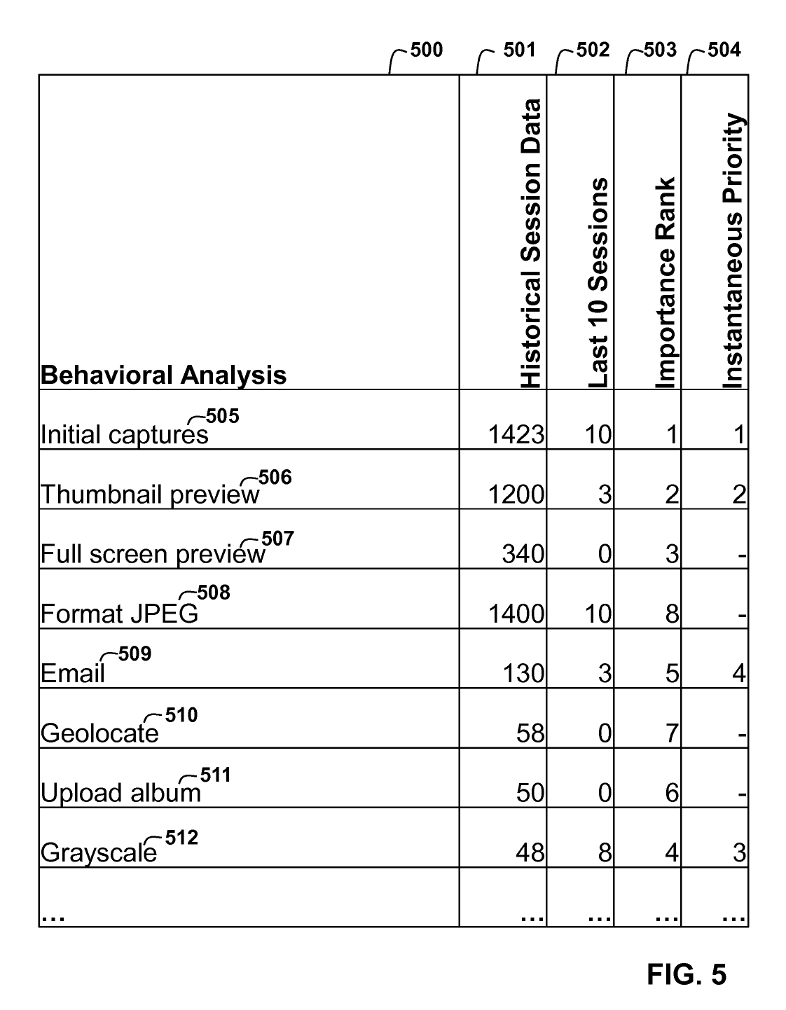

Since the user is neither aware nor concerned about the background, the Perceived Processing Time of the proposed method 307 is the difference between Ready1 311 and Ready4 312. This time is significantly shorter than that of the typical method's Perceived Process Time 300. The improvement is generally anywhere from 2× to 10× depending the camera operation, and can be further accelerated using dynamic behavioral analysis shown in FIG. 5.

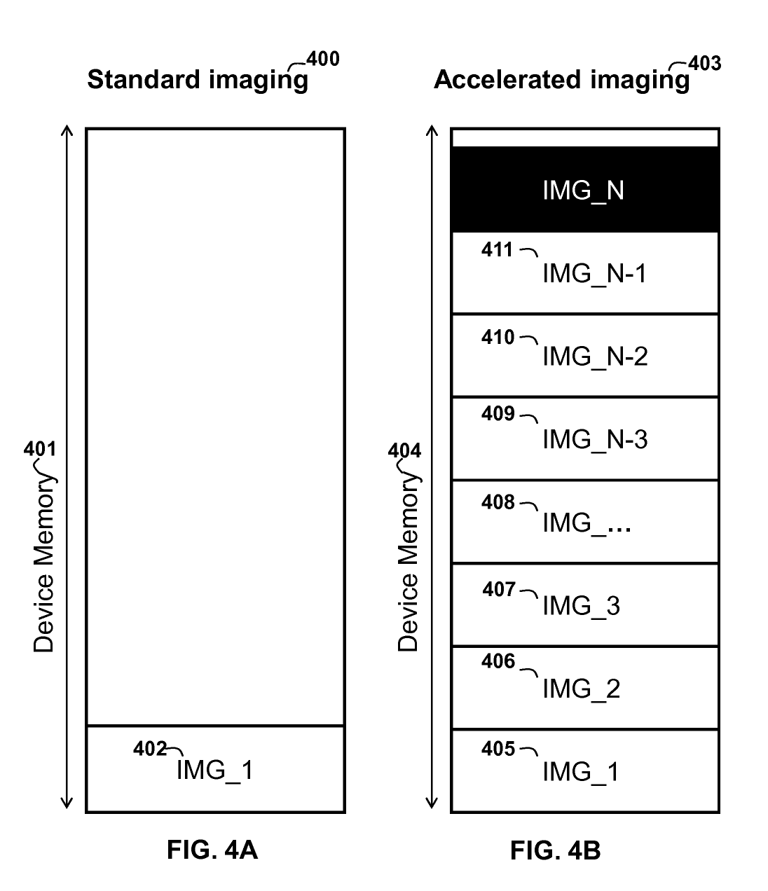

FIGS. 4A and 4B compare the memory map utilization between the standard and the proposed camera operation method. The proposed method consumes more device memory in effort to accelerate the camera operations, which could be a limiting factor depending on the device's memory size.

Referring now to FIG. 4A, a memory map utilization for standard camera operations method 400. The standard technique serializes the image captures, thus at any given time, there is at most one image 402 stored in the memory 401.

Continuing now with the FIG. 4B, a corresponding memory map utilization for the proposed camera operations method 403. The proposed method stores any time-uncritical tasks in task queue, and the associated data in memory. At any given time, there could be multiple images in the device memory 404. In the example shown, the device stores a maximum of N images 405-412 simultaneously.

Upon storing IMG_N 412, the application detects insufficient memory storage and enters maximum memory utilization mode. In this mode, the application prioritizes the tasks in the task queue over new requests, essentially reverting back to a serial mode similar to that of standard method 400. In the worst case scenario, although the application must free up memory prior to taking new requests, the overall throughput rate is no less than the standard camera option method. Physically, if the user continuously performs action under software acceleration faster than the rate at which actions can be processed, at some point the proposed camera application must revert back to the non-accelerated mode. As device memory grows in future camera devices, this will become less of an issue.

In the case where camera user prematurely exits the camera application prior to completing all tasks in queue, the application initiates exit protection procedures to operate in the background until all images are processed. To prevent slowing of other application's performance, exit protection procedures operate in the background only when the processor is not under full load. Certain camera devices forbid exited applications to run in the background. In these devices, the application can either wait until all images complete processing or discard the images in memory for a prompt exit.

FIG. 5 shows a sample behavioral analysis using the proposed method.

Referring now to FIG. 5, an analysis of user behavior 501 can be used to optimize the proposed method to further accelerate the camera operations. The method speculates the possible user actions and pre-computes the speculative results prior to processing the time-uncritical tasks. In the example shown, the analyzed camera operation is an image capture sequence but the method is not limited to it. All camera operations can use this speculative technique on various level of granularity.

Upon receiving any user request, the application updates the corresponding cells in FIG. 5 to keep track of the user's behavioral trends. Depending on the historical 501 as well as the latest 502 trends, the application ranks each task's importance 503 as well as its instantaneous priority 504. Using this information, the system predicts user's next possible moves and dynamically prioritizes tasks in the task queue to further accelerate the user feedback on the camera operation request.

The sample record of user actions in FIG. 5 shows historically that Initial captures 505, Thumbnail preview 506 and Format JPEG 508 are the three most popular actions. According to the sample data, these actions occur on almost every image capture sequence.

Historically, some less frequent actions are Full Screen Preview 507 and Email 509. The user roughly previews one out of every four images and emails roughly one out of every 10 images. This indicates that the user do use these features but not on a consistent basis.

The infrequent actions on the matrix are Geolocate 510, Upload album 511 and Grayscale 512.

The historical data alone is not enough to determine each task's priority. The application keeps track of the latest actions as well. In the matrix shown, it appears that Initial Capture 505 and Format JPEG 508 remain frequently used, but the user rarely uses the Thumbnail Preview. The application also observes a dramatic increase in the Grayscale 512 requests in the recent operations.

The frequent grayscale image manipulation requests are a drastic change in the user behavior which could be a result of a new camera user operating the camera. The application can speculate this behavior and dynamically-prioritizes the task queue to generate an even more accelerated response to the end user. In effect, before processing the standard sequence of tasks for an image capture, the application pre-computes the grayscale results for the next image first from speculation that it might be the user's next request. If the speculation is correct and the user requests a grayscale action, the on-screen grayscale result preview would be instantaneous because the image has been pre-computed. If the speculation is incorrect, the pre-computation would add to the total background processing but would still not affect the user's on-screen performance in any way.

The historical data 501 shows the popular general actions from the user, while the current data 502 shows any recent trends. The application combines the two source of information to calculate the importance 503 ranking. The importance rank 503 differs from the instantaneous priority 504 where the importance rank doesn't take in consideration of any technical limitations. In some instances, one action must precede another due to technical reasons. The Instantaneous Priority 504 takes in consideration of both technical limitations and the importance ranking to suggest the most optimized task queue priority list.

In the case where behavior-tracking is not feasible, the method proposes to pre-seed priority information to still achieve great results. Experiments are used to gather behavioral information from large pool of camera users and later infer into priority ranking.

Due to the generally predictable user behavior, proposed method with these pre-seeded data produces great acceleration on the common camera operations. The trade off for not keeping up-to-date behavior information is the inability to cope with any user behavior that drastically differs from the norm.

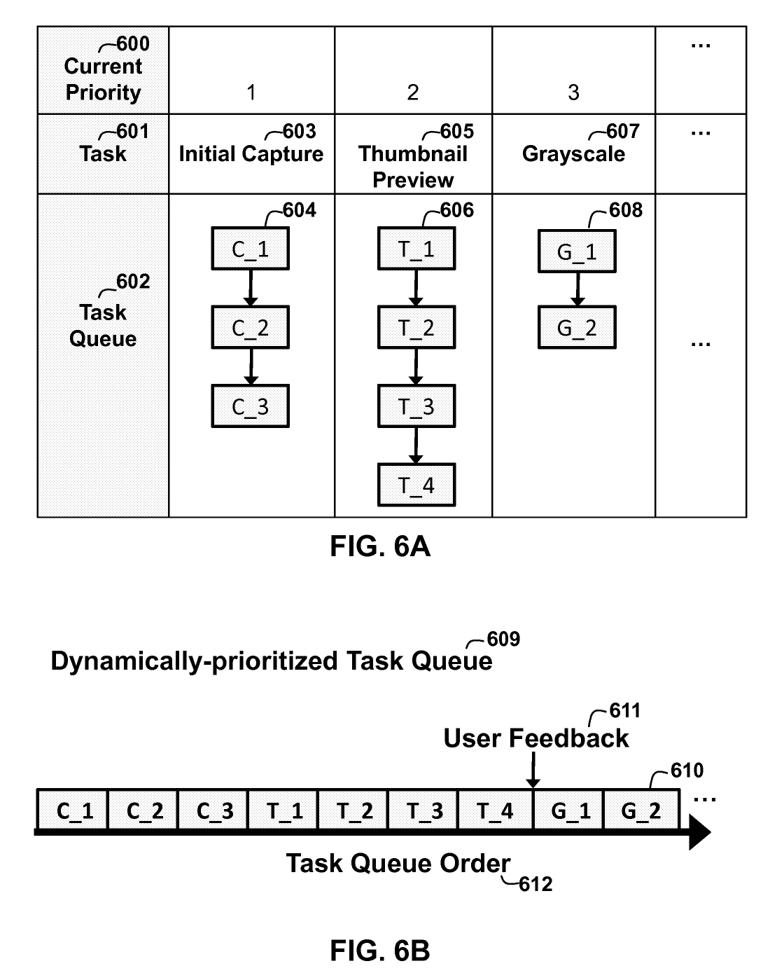

FIGS. 6A and 6B illustrate the uses of behavioral data to dynamically prioritize the task queue in the proposed method.

Referring now to FIG. 6A, a table of each task's current priority 600 derived from the behavioral data in FIG. 5. In this table, each main task 601 is made up of smaller sub-tasks 602. As an example, an Initial Capture 603 task is broken down into 3 smaller sub-tasks, which are “Resets Camera Image Sensor”, “Wait T Milliseconds” and “Read Camera Image Sensor Value Into Memory”. Dynamically-prioritized queuing can be done on any level, but it is generally done on the main task level as the orders of sub-tasks are mostly hardware dictated. The illustration generalizes the three sub-tasks of Initial Capture 603 as C_1, C_2 and C_3 604. Similarly, denote Thumbnail Preview sub-tasks 605 as T_1 to T_4 606 and Grayscale sub-tasks 607 as G_1 and G_2 608.

Continuing with FIG. 6B, the application assembles the dynamically-prioritized task queue 609 upon the next image capture request. When the user issues the operation request 204, the application dynamically schedules the necessary tasks 213 according to its current priority table 600. The resulting dynamically-prioritized task queue 612 optimized to the user's behavior. Upon the image capture request, the application follows this queue to first processes C_1 to C_3 604 of the Initial Capture steps 603, then steps T_1 to T4 of Thumbnail Preview steps 605. A User Feedback 611 is generated at this point to preview the captured image. Prior to completing the remaining post-processing steps, the application first pre-computes grayscale preview G_1 and G_2 607 of the captured image in anticipation for a likely grayscale conversion request. From this time onward, any grayscale conversion request would result in near instantaneous feedback because the data has been pre-computed.

The instantaneous feedback does not require a full resolution image, thus for speed the grayscale conversion is only pre-computed for the preview size resolution. The full resolution grayscale is a time-uncritical task that is processed at a later time if needed. The amount of added pre-computation for grayscale preview 607 is relatively small. However, the resulting instantaneous feedback greatly accelerates the perceived camera operations speed and significantly improves the user experience.

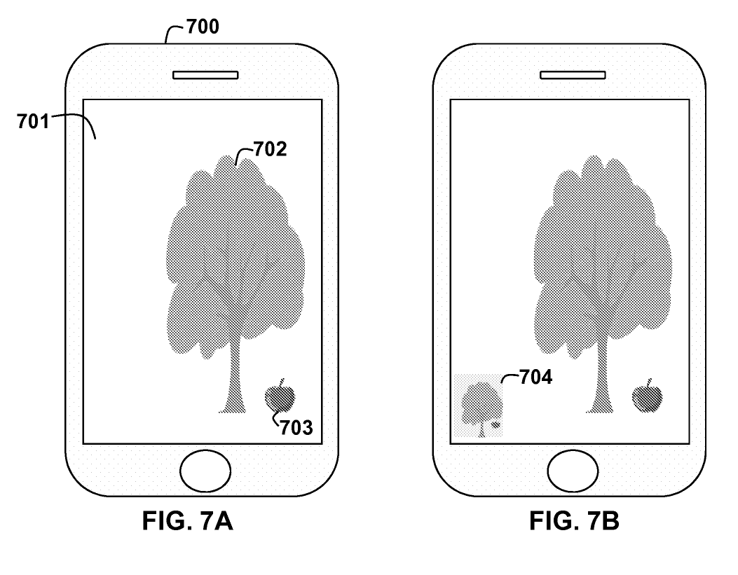

FIGS. 7A and 7B illustrate the proposed software acceleration from the camera user's perspective.

Referring now to FIG. 7A, the figure shows the setup of proposed camera application in the preferred embodiment of an embedded camera device 700. The viewfinder 701 is the rectangular screen with touch screen capability. The viewfinder 701 shows a stationary object 702 and a moving object 703 in the view of the camera.

Continuing with the FIG. 7B, the figure shows an example of accelerated feedback 208 through the proposed method. Upon capturing an image, the system utilizes minimal computing 207 to generate a captured image thumbnail 704 on the viewfinder as a part of the interactive on-screen feedback.

The interactive feedback is layered on top of live updating viewfinder, but not obstructing the main view. In effect, the feedback is readily available, but does not obstruct the user from any camera operations. The interactive feedback can also hide completely if requested.

The interactive feedback generates the thumbnail to signal to the user that the device is ready for more actions 200. Although the image is not yet fully processed, the user can fully interact with the image to perform any camera operations. Thus as the user is concerned, processing in association to the camera operation is complete the moment the user can fully interact with the captured image.

One way to implement the thumbnail preview is to sub-sample a screen resolution size and a thumbnail size image from the original full resolution image in software. Another method is to utilize the existing hardware to capture a smaller screen-sized image prior to capturing the full resolution image. The two resulting images are roughly the same unless there is significant camera movement. Depending on the device capability, the hardware assist can further accelerate the camera operations using the proposed method.

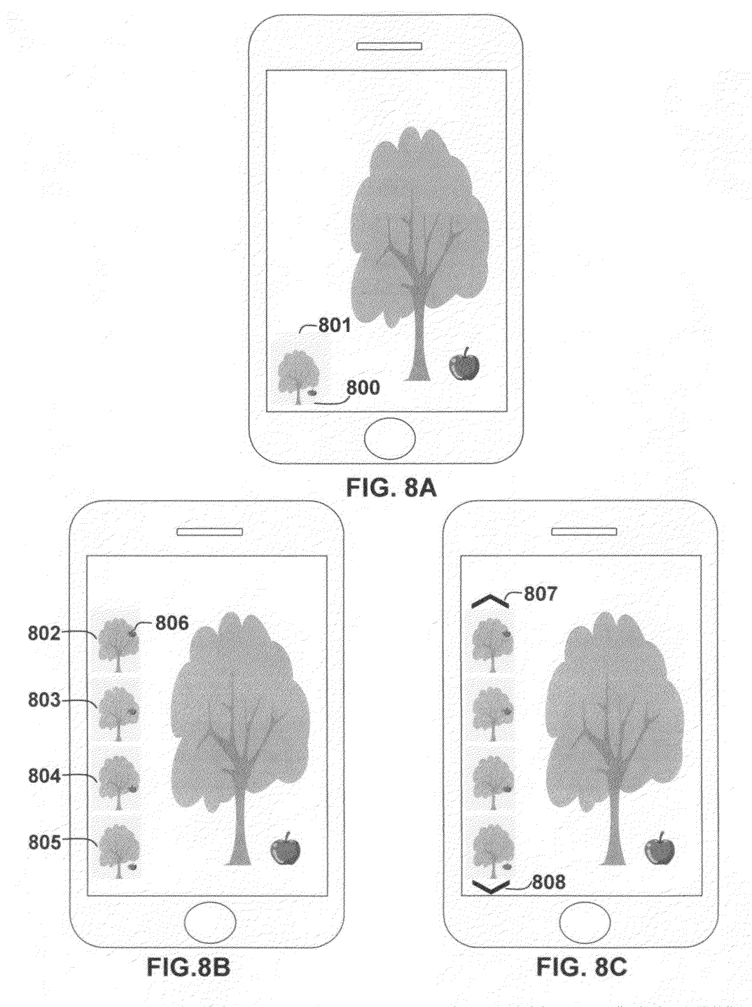

A wide range of common image management options are shown in FIGS. 8-14. These common image management options typically include but are not limited to image viewing, image manipulation, deletion, emailing, sharing and printing.

FIGS. 8A, 8B and 8C illustrate the preview aspects of the interactive on-screen feedback, which along with all the feedback, is available to the user immediately after an image capture.

Referring now to FIG. 8A, the proposed method produces a small thumbnail 800 of the image taken on the viewfinder. The shadow stack behind the thumbnail 801 indicates there are more thumbnails behind the uppermost thumbnail.

Continuing with the FIG. 8B, tapping once on the thumbnail 805 spreads out the stack and shows the last few images taken. In the example, the last 4 images taken are shown on the screen 802, 803, 804, 805. The movement of the falling apple 806 indicates that the image stack is shown in chronological order. To revert back to the thumbnail stack in FIG. 8A, tap once again on the thumbnail 805 compresses the column of thumbnails.

Continuing with the FIG. 8C, to view other images thumbnails in the camera roll or album, tap on the arrows 807, 808 to scroll through image thumbnails. In an alternative implementation, an up/down swiping gesture can also be used to scroll through the list of image thumbnails in the camera roll or album.

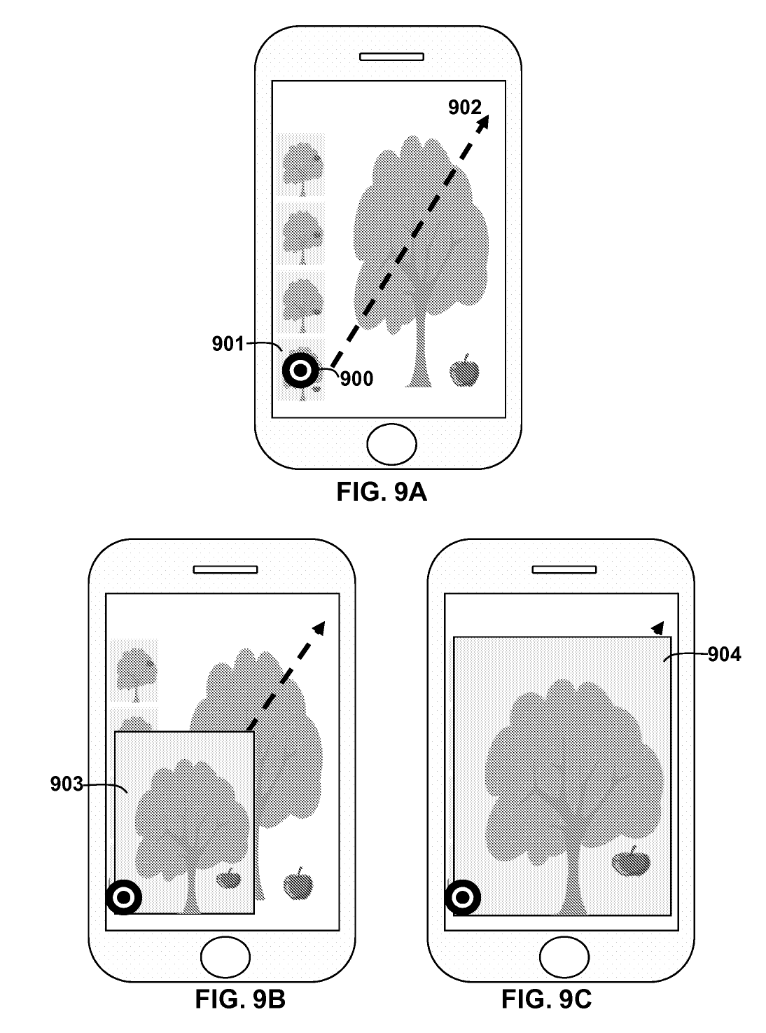

FIGS. 9A, 9B and 9C illustrate additional preview features of the interactive on-screen feedback.

Referring now to FIG. 9A, the figure shows the application with thumbnail preview in the column format. The concentric rings 900 indicate a touch input from the user.

Continuing with the FIG. 9B and 9C, the figures illustrate the steps to further examine an image in the column. Press and hold any thumbnail 901 and the thumbnail quickly expand 902 from thumbnail 903 into a full screen sized image 904. To revert back to the thumbnails, release the hold from the screen and the full sized image shrinks back to a thumbnail.

To maximize the operation's feedback speed, the implementation stores both the full-screen and thumbnail sized versions of the image in memory. A circular queue can be used to store these data as the user only has access to a limited number of images at a time on the viewfinder. This implementation help minimizes the memory footprint while maximizes the feedback speed.

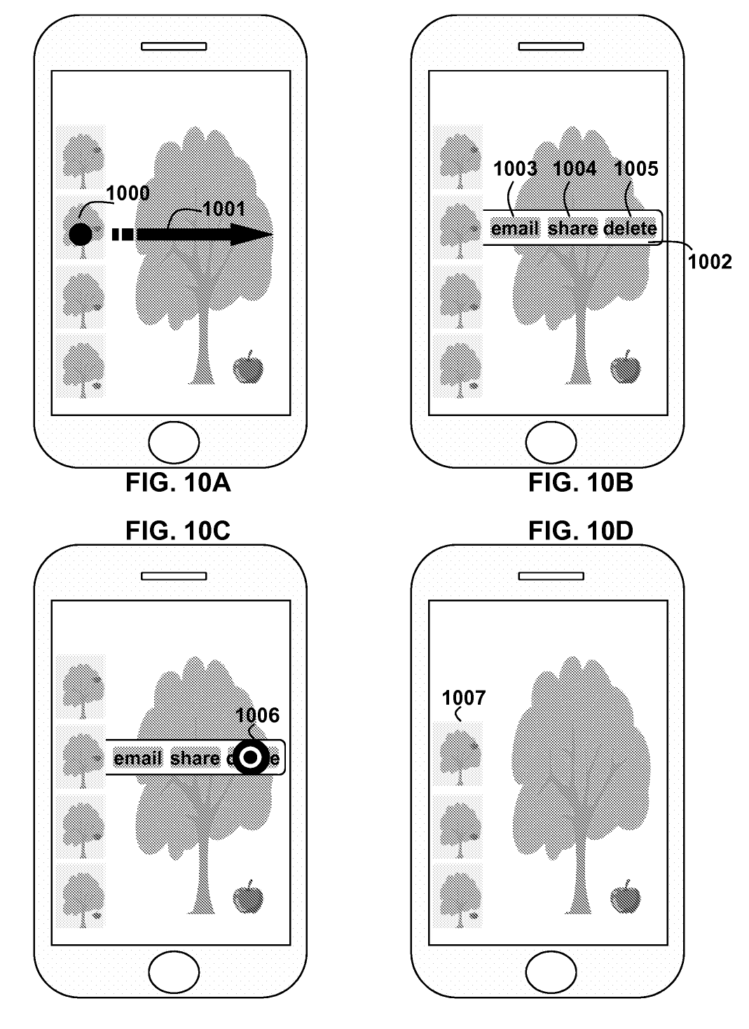

FIGS. 10A, 10B, 10C, 10D illustrate the image management aspects of the interactive on-screen feedback.

Referring now to FIG. 10A, the user slide a thumbnail 1000 to the opposite side of the screen 1001.

Continuing with the FIG. 10B, this sliding action brings up a menu 1002 of options overlaid on top of the live updating viewfinder. In the example shown, the three options are email 1003, share 1004 and delete 1005.

Continuing now with FIG. 10C and 10D, illustrations of image deletion sequence. Once the menu is present, the user clicks on delete button 1006 to issue a deletion command to the application. The deleted image disappears from the column 1007 and the uppermost thumbnail drops down by one spot.

Unknown to the user the deletion only occurs on screen while the actual computing is done at a later time. The minimal processing 220 provides immediate user feedback 221. Meanwhile, the insert deletion related tasks in the task queue 222 for processing at a later time. This implementation help maximizes the feedback speed for the deletion operation.

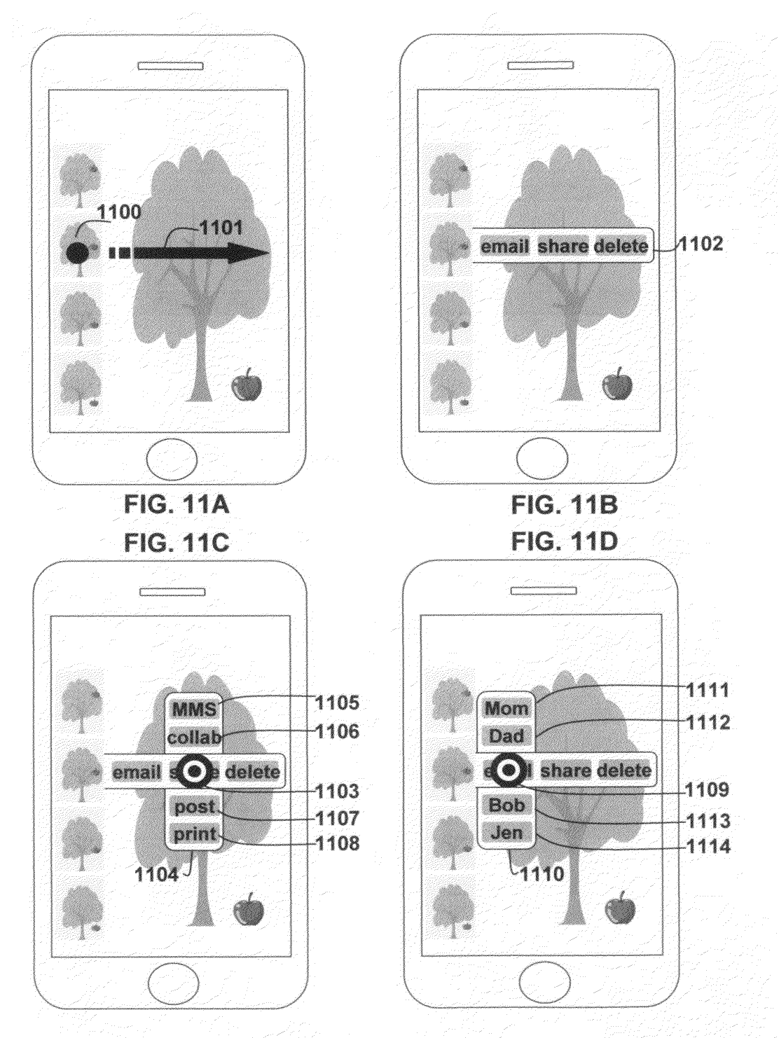

FIGS. 11A, 11B, 11C and 11D illustrate the extensibility of the interactive on-viewfinder menu.

Referring now to FIG. 11A, the user selects a thumbnail 1100 and slides it to the opposite side of the screen 1101.

Continuing with the FIG. 11B, the slide action brings up a menu of options 1102.

Continuing with the FIG. 11C, the user presses and holds 1103 the share button and brings up a submenu 1104. The submenu contains a list of sharing related features. In the example shown, the four options are Multimedia Messaging System 1105, Collaboration 1106, Post 1107, and Print 1108. The submenu overlays on top of the live updating viewfinder. Similar to the overlay menu, the submenu is also customizable per the application.

Continuing with the FIG. 11D, in the same fashion as the share option list, the user can press and hold 1109 the email button to bring up a list of relevant email options 1110. The four email shortcut options shown are emails to Mom 1111, Dad 1112, Bob 1113, and Jen 1114.

The application submenu is customizable by design. Depending on the device and requirement, the application can show different submenu to provide options for different possible operations.

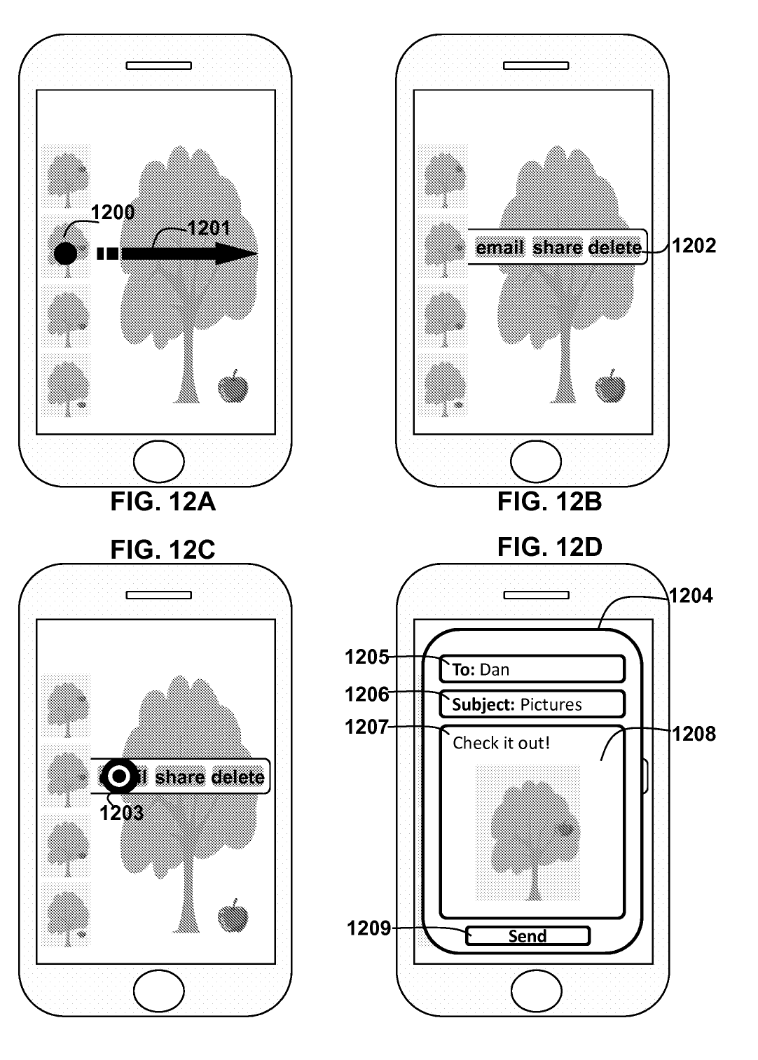

FIGS. 12A, 12B, 12C and 12D illustrate the ability to execute other applications on the interactive screen.

Referring now to FIG. 12A, the user selects a thumbnail 1200 and slides it to the opposite side of the screen 1201.

Continuing with FIG. 12B and 12C, the slide action brings up a menu of options 1202 and the user selects email 1203 from the available options.

Continuing with FIG. 12D, without exiting the camera application, the action triggers a full screen email form 1204. This is a customized version of the device's email application designed to work specifically to work within the camera application.

The camera application pre-seeds some or all of the sections on the form, which includes To 1205, Subject 1206 and Body 1207 section. The body 1208 section of the form is automatically filled in with the selected image. Once the user selects Send 1209, the form disappears and the live viewfinder is once again visible.

Emailing the image does not exit the camera application, loads up the email application, nor does the application process the email right away. The application performs the minimal processing to generate the email form, and then inserts the time-uncritical tasks in the task queue for later processing. This technique significantly accelerates the emailing operation by avoiding potential long delays in communication. The camera application is able to execute other applications in the same fashion without worries of major performance impact.

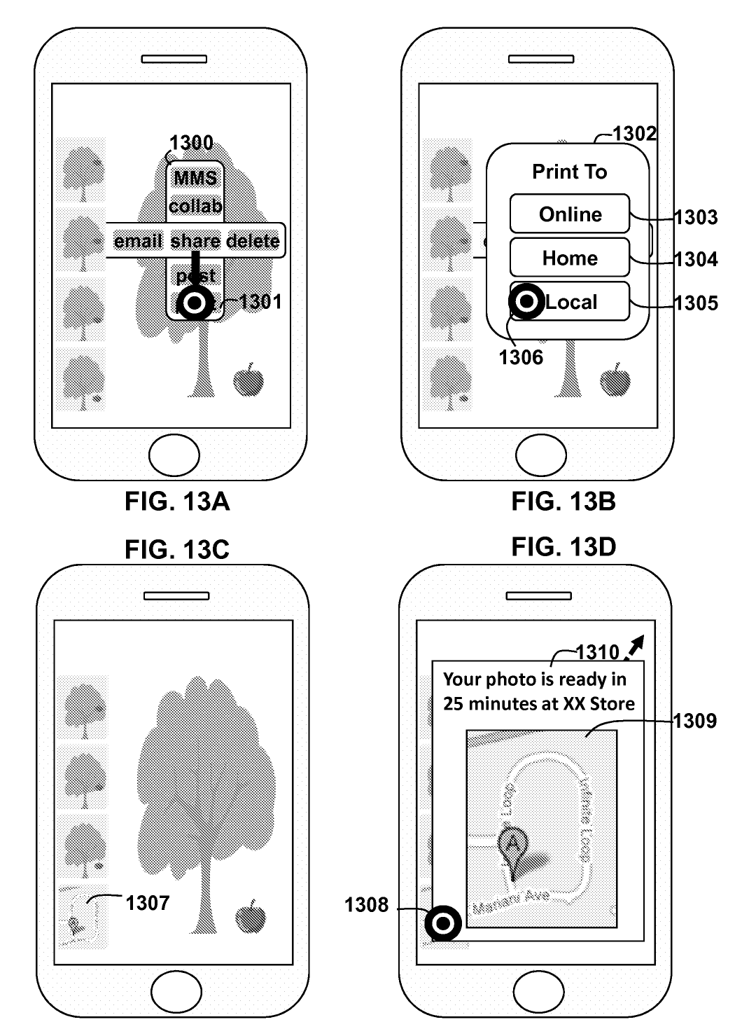

FIGS. 13A, 13B, 13C and 13D illustrate the capability to provide additional non-image information to the end user through the interactive interface.

Referring now to FIG. 13A, the user selects to perform Print 1301 from the feedback submenu 1300.

Continuing with the FIG. 13B, without exiting the camera application, a menu 1302 appears to inquire where the user would like to print the image. The three options given in the example are Online Printing Services 1303, Home Printer 1304, or Local Printing Services 1305. The user opts to print locally 1306. In the system background, the application immediately locates the nearest photo printing store and automatically exchanges the appropriate data and information. These tasks are processed in the background to avoid potential long communication delays. Information transfer from the application to the internet is a time-uncritical task that can fully utilize software acceleration as shown in the next figure.

Continuing with the FIG. 13C, the application consolidates the retrieved information into a thumbnail 1307 on the viewfinder. If long communication delay is expected, it is possible to build the feedback thumbnail incrementally. The application first provides immediate thumbnail feedback from a stored template, and then adds to the thumbnail as more information is received.

Continuing with the FIG. 13D, the user can hold and enlarge 1308 the thumbnail to obtain more detailed information. In the example shown, detailed information include a map of the photo printing store 1309, as well as store's best estimate on when the printouts are ready 1310.

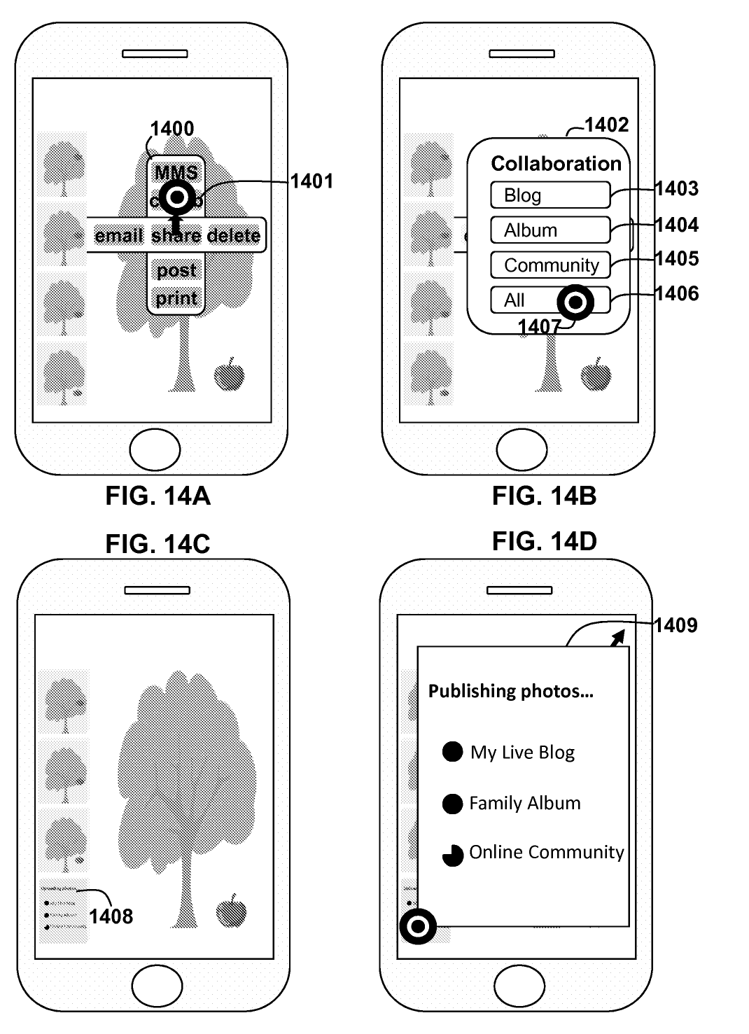

FIGS. 14A, 14B, 14C and 14D illustrate the capability for the user to receive live update through the interactive interface.

Referring now to FIG. 14A, the user selects to perform Collaboration 1401 from the feedback submenu 1400.

Continuing with the FIG. 14B, without exiting the camera application, a menu 1402 appears to inquire which type of Collaboration the user would like to perform. In the example given, the four send options are to Blog 1403, Album 1404, Community 1405, or all of the destinations above 1406. The user chooses all of the above 1407 option.

Continuing with the FIG. 14C, upon receiving user's selection, the application performs the minimal tasks involved to generate a feedback to the user. These tasks are given the highest possible priority in the task queue to be processed immediately. Once the application completes these tasks, a thumbnail 1408 feedback appears on the viewfinder to acknowledge the camera readiness for more actions.

Continuing with the FIG. 14D, the user can hold and enlarge 1409 the feedback thumbnail. The information shown on this feedback thumbnail is a live, update of the dispatched operations' progress. The application actively monitors its communication with the third party sources including any notifications. The feedback thumbnail periodically updates to reflect the latest information. Due to various limitation factors, tasks involving third party can potentially take a long time to complete, which causes the user to lose track of the progress. The feedback thumbnail addresses this issue in two ways without interfering with the user's activity or exiting the camera application. First, it allows the user to passively monitor the live progress of these time-consuming tasks. Second, it allows the user to quickly and easily expand the thumbnail to get detailed information on these tasks if needed.

While various embodiment of the present invention have been shown and described, it should be understood that other modifications, substitutions and alternatives can be made without departing from the spirit and scope of the invention, which should be determined from the appended claims.

What is claimed is:

1. A software method to accelerate perceived digital camera's operations by optimizing the task queue to camera users' behavior, comprising the steps of:
a) model the image capture behavior from the user as non-predictive, low-duty, and processing intensive events;
b) upon an image capture or other operation request, process the minimal required tasks, queue up the remaining delayed tasks, then immediately allow more request for image capture or other operation;
c) simultaneously provide interactive feedback to the user to acknowledge the camera's readiness for more actions, and allow user access to the captured images;
d) finish processing the remaining delayed tasks in the queue once the device finishes minimal required tasks and the device's processor is not under full load.

2. The method as defined in claim 1, wherein the minimal required tasks are defined as the minimal amount of time-critical tasks that must be completed right away in a particular camera operation. The remaining tasks in the camera operation are defined as delayed tasks.

3. Minimal required tasks and delayed tasks as defined in claim 2, such that the tasks are ordered by prerequisite necessity, pre-defined priority, and by time the task is issued.

4. The method as defined in claim 1, wherein the system queues up the non-time-critical tasks according to processing order necessity in conjunction with real-time assigned priority, and is then automatically processed during processor low-duty times.

5. The method as defined in claim 1, wherein the camera software temporarily stores all delayed task data in cache to achieve the minimum times between captures and other operations.

6. The method as defined in claim 1, wherein the minimum times between captures and other operations are achieved as long as the cache memory is available. Once depleted, the capture and process rate will return to non-accelerated speed.

7. The method as defined in claim 1, wherein the software provides user with immediate feedback that the device is ready for another image capture via either
a) removal of any busy signal or similar response; or
b) addition of any ready signal or similar response.

8. The method as defined in claim 1, wherein one aspect of the interactive feedback gives the user option to visualize the captured images right on the camera viewfinder while in capture mode, in the forms of
a) a single, collapsed thumbnail view of the image most recently captured; or
b) an expanded thumbnail view of the most recent images captures; or
c) a further expandable or scrollable thumbnail view of the all images in the camera roll and the camera album; or
d) an expandable enlarged view of any thumbnail for closer inspection; or
e) a hidden view where the thumbnails are cleared from the viewfinder.

9. The method as defined in claim 1, wherein another aspect of the interactive feedback allows the user to perform on-viewfinder thumbnail actions. The camera software provides instant verification feedback in response, and later translates the on-viewfinder thumbnail actions to actual image actions.

10. The on-viewfinder thumbnail actions as defined in claim 8, wherein the user can use gestures to
a) make any post-capture image modifications and manipulations;
b) delete or move one or more images;
c) share one or more images by email, upload, posting, and direct transfers;
d) print one or more images to a local or network printer service.

11. The method as defined in claim 1, wherein the user behavioral model dynamically updates by tracking device usage. The method then utilizes this user-specific behavioral information to further optimize the intelligent task queuing and further accelerates device's response time.

12. The method as defined in claim 11, wherein the method detects trends in user behavior, and pre-computes on-screen feedback information in anticipation to the upcoming user requests.

13. The method as defined in claim 11, wherein if dynamic tracking of user behavior is not possible, the system can still utilize a pre-computed user behavior model for the general camera users.
